(19) United States
(12) Patent Application Publication
(10) Pub. No.: US 2017/0286909 A1
(43) Pub. Date: Oct. 5, 2017

(54) Configure-Price-Quote Systems For Partner Networks

(71) Applicant: Baynes Associates LLC, Stafford, MO (US)

(72) Inventor: Timothy Baynes, Stafford, MO (US)

(21) Appl. No.: 15/474,651

(22) Filed: Mar. 30, 2017

Related U.S. Application Data
(60) Provisional application No. 62/317,482, filed on Apr. 1, 2016.

(51) Int. Cl. G06Q 10/10; H04L 29/06; G06Q 10/06

(52) U.S. Cl. CPC G06Q 10/101; G06Q 10/067; H04L 63/102

(57) ABSTRACT

An apparatus and method for configuration-price-quoting in a shareable manner across multiple sites with multiple users is presented. Some embodiments include a multiuser site on a global computer network. Embodiments may generate or receive product models for a multiuser site. The product models may be shareable amongst users of the multiuser site. Embodiments may enable the users to setup access rights of other users to the product models, such that different users have access rights to different product models of other users. Embodiments may enable some users to modify or extend the shared product models, or include them in models of their own. Each product model may relate to one or more respective manufacturable products. Each product model may include: product data of the manufacturable product, configuration rules, and prices for the manufacturable product. A user with access rights to shared product models may execute the product model to produce a certain price quote for a user-selected configuration of the corresponding manufacturable product. Users may create price quotes for configured products from multiple manufacturers. Users may create configurations of systems that include configurable products from multiple manufacturers.

### RELATED APPLICATION

This application claims the benefit of U.S. Provisional Application No. 62/317,482, filed on Apr. 1, 2016. The entire teachings of the above application are incorporated herein by reference.

### BACKGROUND

Complex business functions are often automated by computer software. Some types of business functions entail a transaction or collaboration with a business partner, for example the resale of goods by a reseller. For certain types of business functions, it can be useful for data and even computer software code to be shared with one's trading partner. An example is the class of business systems called configure-price-quote (CPQ) systems. Reselling a manufacturer's configurable products can be facilitated if the reseller can access the manufacturer's product configuration data and rules. Existing software systems do not easily allow business partners to share information with one another, and rely on expensive integrations or portals so a business entity can extend access to configuration data and pricing to its partner.

### SUMMARY OF THE INVENTION

This disclosed apparatuses, systems, and methods overcome the limitations of existing systems by enabling partners to share data and custom application code with each other. A user of the system (for non-limiting example, a customer user) may include a business entity whose agents are authorized to use the system. Other users of the system may include those users affiliated with a business entity's partners. Embodiments may include but are not limited to one type of complex business software known as a configure-price-quote (or “CPQ”) system. CPQ systems, also known as sales configuration systems, may include software programs which may allow users to create a sales quotation that may include an arbitrary number of products or services, some of which may be configurable. Both products and services (such as complex financial instruments) may be configurable, and herein the term “configuration” is used to apply to both product configuration and services configuration. Products are often sourced from manufacturers, while services are often sourced from service providers. Herein the term “manufacturer” is used to apply to both manufacturers (of products) and service providers (of services). Existing CPQ systems are designed for use by companies, typically manufacturers or service providers, who offer configurable products or services for sale. The systems are normally designed to be administered by agents of the same entity that manufacturers the product (henceforth referred to as the “Manufacturer”). Complex (configurable) products used in business are often sold directly from the manufacturer to the purchasing company. These types of sales may be referred to as business-to-business or B2B transactions. Complex products sold in B2B transactions may include but are not limited to: computer and networking equipment, HVAC equipment, fluid and gas handling and processing equipment, industrial machinery, robotics and automation equipment, heavy vehicles, agricultural equipment, and other types of equipment known to one skilled in the art. Alternatives to a direct B2B sale are business-to-business-to-business (B2B2B) sales, where a reseller sells the manufacturer's business-class products to a purchasing business (i.e., customer), business-to-consumer (B2C) and business-to-business-to-consumer (B2B2C) where a reseller or integrator sells consumer products directly to the end consumer.

CPQ systems may facilitate the process of selling complex, configurable product by automating product configuration. Business rules (“configuration rules” and “pricing rules”) that determine how the product is configured and priced may be encoded in the software application, and may be executed when the user creates a quote for the configured product. The business rules ensure that the product is correctly configured, that required product components are included, and that incompatible product options are preferably not selected. Pricing rules may apply complex logic like bundle discounts to the price.

Configurable products, especially those sold in B2B transactions, can be very complicated. Configuration and pricing rules that govern the configuration and pricing of a complex product can number in the thousands or even hundreds of thousands. Examples of such highly complex products may include cellular network base stations, automated material handling system in a large warehouse, and long-haul semi tractors. Even comparatively simple products such as diesel generators, custom windows, and HVAC air handlers can have hundreds or thousands of business rules.

CPQ software systems are invented to facilitate the complex task of configuring and pricing complex products, such as those mentioned above. CPQ systems may significantly reduce the time that a sales agent requires to produce a sales quotation for a customer, when the products are configurable.

Many manufacturers sell their products directly to their business customers, but also sell their products indirectly through resellers, dealers, or systems integrators (collectively, “resellers”) in B2B2B and B2B2C arrangements. When the product is configurable, resellers may have the same need for configure-price-quote functionality as the manufacturer's direct sales agents.

Existing software systems do not make it easy for resellers to configure and price the configurable products of their manufacturing partners. Ideally, a reseller may have access to a CPQ system, so they can prepare and track their own sales quotations. However, most CPQ systems are designed and set up to be used by the manufacturer and the manufacturer's direct sales agents.

Additionally, many resellers desire to have their own CPQ systems, which are integrated with their own CRM (customer relationship management) systems so they can keep track of sales opportunities. Resellers could set up their own CPQ systems, which may include the configuration and pricing rules for their partners' products. However, the in-depth product knowledge that may be required to set up a configurator may be commercially impractical for most resellers, because of the complexity of the rules and the frequency of product changes. Most resellers would prefer to access product configurators that are directly maintained by the product's manufacturer, if they are able to create and track their own quotations.

Some manufacturers allow their reseller partners to access their CPQ systems by a web portal. Resellers can configure and price the product, and get the necessary information to create a quotation which they then may present to their customer. However, existing portal solutions have two distinct deficiencies (overcome by some embodiments): the existing portals do not allow the reseller to tie the CPQ application with their CRM system, without custom integration, and the existing portals do not allow the reseller to include products from multiple manufacturers on a single quotation.

As such, the disclosed apparatuses, systems, and methods address the deficiencies described above of existing systems. According to some embodiments, a CPQ system (also apparatus and method) is described herein that allows many business entities to share the same system, and to share configuration and pricing rules with one another. The CPQ system (also referred to as “the system” herein) thus provides every user of the system with configure-price-quote functionality, and has the additional benefit of allowing resellers to include the configurable products of one or more partners on their sales quotations.

The disclosed apparatuses, systems, and methods address the deficiencies of the existing CPQ systems in that some embodiments provide shared CPQ access to multiple users across multiple sites. In some embodiments, CPQ applications may embody three primary functional capabilities: configuration, pricing, and/or quotation. In some embodiments, the system may include an administrative function to identify business entities whose users are entitled to use the system. In some embodiments, the system may include a function that may identify users who are affiliated with a business entity, and who may be thereby granted rights to use the system. In some embodiments, CPQ systems may include an administration function that may setup (or “set up”) product data, program configuration rules, configuration-related executable code (such as proprietary product sizing algorithms), pricing data and/or pricing rules. Additionally, CPQ systems may include an administration function that may include the ability to define system access permissions, which may control who (e.g., which users) may use various functions of the CPQ system.

CPQ systems may utilize the following two primary deployment methods:
1. “On-premise or hosted” where the CPQ system software may be licensed to one or more enterprises (also known as businesses or companies herein), and installed and operated on the enterprise's own computer system, or hosted for use by the enterprise on a third party's computer system.
2. “Software-as-a-service” (or “SaaS”) where the CPQ software (also known as software herein) may be already installed and running on a system which may be accessible to one or more enterprises over the internet (“the cloud”). According to some embodiments, cloud software systems may be single-tenant or multi-tenant. Enterprises that are to use the CPQ system may enter into a contractual relationship (e.g., contract) with the software company who may produce and manage the CPQ system, and this contract may entitle the enterprise to use the software. According to some embodiments, an enterprise that is entitled by contract to use a cloud-based CPQ system, single-tenant and/or multi-tenant, may be referred to as a “tenant” herein, given that more than one enterprise may use the method (and system) of some embodiments.

In both deployment methods, the CPQ system may be set up (or arranged, or configured) to serve specific requirements of the user (e.g., manufacturer). According to some embodiments, users of a CPQ system may include, but are not limited to manufacturer users (e.g., manufacturers) or partner users including but not limited to resellers, integrators, and/or dealers.

In some embodiments, each product configuration model may relate to one or more respective manufacturable products.

A model, also known as configuration product model, configurator model and/or product model herein, may include but is not limited to including product data, configuration data, pricing data, pricing rules, prices, graphical data to visualize the configuration, and other supporting executable code or scripts including but not limited to sizing algorithms known to one skilled in the art, and/or other data and/or support known to one skilled in the art.

In some embodiments, one or more users may modify the model. In some embodiments, the user may modify the model by modifying the model setup data that is shared with the user (“product set up data,” “product model setup data,” or model setup data referred to herein). In some embodiments, the user may modify the model prior to compilation (i.e., not at runtime). As such, in some embodiments, user modification of models described herein includes modification of product set up data and/or product model setup data. However, in alternative embodiments, the user may modify the model at runtime (i.e, the user may modify the model after compilation, using one or more approaches known to one skilled in the art).

Each product configuration model may include data of the manufacturable product, configuration rules, supporting executable code, and prices for the manufacturable product or products. In some embodiments, product data may be loaded, product configuration rules may be programmed, pricelists and pricing rules may be set up, and/or quote templates may be developed. One or more versions of data may be released to users to use in preparing sales quotations. Once these tasks are complete, the user (e.g., manufacturer) may then use the CPQ system to prepare sales quotations for the manufacturer's customers.

Some embodiments may include an apparatus (including but not limited to a computer apparatus) a corresponding system (including but not limited to a computer system, also referred to herein as “the system”) and a corresponding method (including but not limited to a computer-implemented method). The disclosed apparatuses, systems, and methods address the deficiencies of existing approaches. Some embodiments are directed to a computer apparatus (and computer system) and a corresponding method for generating or receiving (or accessing) configuration price quotes in a shareable manner across multiple sites. Some embodiments include a computer-implemented apparatus that uses at least one processor and at least one associated memory. The associated memory may have computer code instructions stored thereon, the memory operatively being coupled to the at least one processor such that, when executed by the at least one processor, the computer code instructions cause the computer system to implement one or more features of the embodiments. Some embodiments may include a multiuser site on a global computer network. Some embodiments may include a registry of business entities whose agents (“users”) are authorized to access and use the apparatus. Some embodiments may authenticate individual users of the system, and to identity the business entity with which they are affiliated.

Some embodiments may include a configuration module communicatively coupled to the multiuser site for generating or receiving (or accessing) product models shareable amongst users of the multiuser site. In some embodiments, the configuration module may be communicatively coupled to the multiuser site for generating or receiving (or accessing) product models shareable between the users of different entities of the multiuser site (e.g., hereinafter referred to as “shared” product models).

In some embodiments, the product models and/or product configuration models herein may be used prior to runtime. However, in other embodiments, the product models and/or product configuration models may be runtime product models.

Some embodiments may include a module that allows the “release” of one or more versions of the product model data. Embodiments herein may include a “release” of versions. Alternatively, embodiments herein may also be implemented without a “release” of versions.

The data may be compiled or collated into a format which may be compressed, compiled into machine-readable form, and/or encrypted. As such, the data may be easy to distribute or access, efficient to store and process, and/or secure.

According to some embodiments, in a release process, a user-defined version of data may be duplicated on the system, so that the original data may be changed or updated without affecting the copied data. The copied data (hereafter referred to as a “release” or as “released data”) may be made available to users for use in preparing quotations. In some embodiments, data described herein (including but not limited to original data, copied data, or other data described herein) may be considered to be data prior to runtime. However, in other embodiments, the data described herein (including but not limited to original data, copied data, or other data described herein) may be considered to be runtime data.

Some embodiments may include a module that may allow the release of a set up data for product, product configuration models, pricing data and/or rules. In a release process for setup data, a user-defined subset of set up data may be duplicated on the CPQ system, so that the original set up data may be changed or updated without affecting the copied set up data. The copied set up data (also herein referred to as “released set up data”) may be made available to partners, so that partners may modify the released set up data, extend the released set up data with components that the partners provide, or include the released set up data as part of their own system configuration models.

Some embodiments of the apparatus (system) and method may include an administration module enabling the users to setup access rights of other users to the received (or generated or accessed) released versions of product models, such that different users have access rights to different received (or generated or accessed) released product models of other users.

According to some embodiments, the administration module may enable the users to setup access rights of other users (for non-limiting example, users associated with business entities other than their own) to the generated released product models, such that different users affiliated with one entity have access rights to different generated released versions of product models shared by users from one or more other business entities (and/or users).

In some embodiments, each received (or generated or accessed) product model may relate to one or more respective manufacturable products. Each received (or generated or accessed) product model may include one or more of product data of the manufacturable product, configuration rules, supporting data or executable code, and prices for the manufacturable product.

According to some embodiments of the apparatus (system) and method, a user may access and execute the released versions of product configuration models and pricing rules of their own affiliated business entity, and also access and execute configuration models that have been release and shared by one or more other business entities (partners), without any modifications to the system other than set up.

A user with access rights to the received (or generated or accessed) released product model may execute the received (or generated or accessed) product model to produce a certain price quote for a user-selected configuration of the corresponding manufacturable product or service. In some embodiments, the apparatus (system) and method may enable a user to access released product configuration models and prices of their own (meaning: of the business entity with which they are affiliated), while also enabling a user to access released production configuration models and prices that have been shared with the user by other business entities, without any modification to the apparatus (system) and method being necessary.

In some embodiments of the apparatus (system) and method, the user may have access rights including but not limited to access rights to the received (or generated or accessed) released product models. In some embodiments, the product models may be prior to runtime. However, in other embodiments, the product models may be runtime product models. The user may further execute the received (or generated or accessed) released product model to access, define, create, specify, or select one or more (e.g., multiple) configurations of the corresponding manufacturable product or service.

In some embodiments of the apparatus (system) and method, the administration module (and/or configuration module) enables the user with access rights to modify, enhance, and/or extend the product models shared with at least one other user (and/or with themselves) or to incorporate the product models into other configuration models of the user. In other embodiments of the apparatus (system) and method, the administration module enables the user with access rights to modify, enhance, and/or extend the product models that have been shared with at least one other user (and/or with themselves), or to incorporate the shared product models into other configuration models of the user. In some embodiments, the user may modify models shared with him. In other embodiments, the user may modify models shared with other users.

In some embodiments of the apparatus (system) and method, the administration module further enables the users to setup the access rights of other users, including users affiliated with business entities other than the user's own business entity, to released and shared product models and product setup data (including but not limited to product model setup data), such that different users have access rights to different product models and set up data of other entities and authorizations to perform specific operations upon the data to which the different users have access; and further comprising: a set up module enabling users to define product, configuration, and pricing data, and controls access to such data so that no user may access data to which the user is not entitled, nor perform operations for which the user is authorized; and a release module that creates a version of a set of product, configuration, and price data for sharing with other users, and controls access to such data so that no user may access data to which the user is not entitled, nor perform operations for which the user is authorized; where a user may access, create, update, and otherwise manage product, configuration, and pricing data for the entity with which the user is affiliated; where a user may assign access rights to the data of the user's own affiliated entity, and authorize specific operations upon such data; and where a user may release a version of product, configuration, and pricing data to be used by entitled users for the purpose of preparing sales quotations for configured products.

In some embodiments of the apparatus (system) and method, the administration module further enables the users to setup the access rights of the other users, including users affiliated with business entities other than the user's own business entity, to released and shared product models and product setup data (including but not limited to product model setup data), such that the different users have access rights to the different product models and set up data of other entities and authorizations to perform one or more operations upon the data to which the different users have access. Some embodiments may further comprise: a set up module enabling users to define product, configuration, and pricing data, configured to control access to the product, configuration, and pricing data such that a user may access data to which the user is entitled and perform operations for which the user is authorized; and a release module that creates a version of a set of the product, configuration, and price data for sharing with the other users, configured to controls access to the product, configuration, and price data such that a user may further access data to which the user is entitled and further perform operations for which the user is authorized. According to some embodiments, a user may access, create, update, and otherwise manage the product, configuration, and pricing data for the entity with which the user is affiliated. According to some embodiments, a user may assign access rights to the data of the user's own affiliated entity, and authorize specific operations upon the affiliated data. According to some embodiments, a user may release a version of the product, configuration, and pricing data to be used by one or more entitled users to prepare one or more sales quotations for configured products. According to some embodiments, the user may have access rights to the product model and may further execute the product model to access (and/or create) multiple configurations of the corresponding manufacturable product and/or service.

The user may include at least one of a manufacturer user and a partner user. The partner user may be at least one of a reseller, an integrator, and a dealer. The manufacturer user may access the administration module to release product models. The manufacturer user (e.g., as owner of the data) may access the administration module to indicate (or grant, or entitle), with respect to one or more other users, access to the received, generated, accessed, released, and/or shared product models (“product models” and “product models” may be considered received, generated, accessed, released, and/or shared herein).

According to some embodiments, through an administration module, the user may have access rights to modify or extend the received, generated, accessed, released, and/or shared product models (and/or product models, either prior to, or at runtime). According to some embodiments, through an administration module, the user may execute the product models or use the product models to create configurations. In some embodiments, the user may modify shared setup configuration and/or pricing models.

One or more other users may access the received, generated, accessed, released, and/or shared product models and the partner user may execute the product models to perform price quoting.

An alternative embodiment is directed to a non-transitory computer readable medium having stored thereon a sequence of instructions which, when loaded and executed by a processor coupled to an apparatus, may cause the apparatus to: generate, by a processor, product models for a multiuser site, the received (or generated or accessed) product models being comprised of released data and/or being shareable amongst users of the multiuser site; and enable the users to setup access rights of other users to the received (or generated or accessed) released product models, such that different users have access rights to different received (or generated or accessed) released product models of other users. Each received (or generated or accessed) product model may relate to one or more (e.g., single or multiple) respective manufacturable products and may include: product data of the manufacturable product, configuration rules, and/or prices for the manufacturable product. A user with access rights to the received (or generated or accessed) released product model may execute the received (or generated or accessed) product model to produce a certain price quote for a user-selected configuration of the corresponding manufacturable product or service.

The user may have access rights including but not limited to access rights to the received (or generated or accessed) released product models. The user may include at least one of a manufacturer user and a partner user. The partner user may be at least one of a reseller, an integrator, and a dealer. The manufacturer user may access the administration module to indicate, with respect to the other users, access to the received, generated, accessed, shared, and/or released product models.

Some embodiments may include an administration module enabling users to control the manner in which released products models may be used by the users with whom the data has been shared. For example, a manufacturer may specify that resellers may have a right to modify prices of the manufacturer's resold products. The user may access the received (or generated or accessed) released product models. The user may execute the released product models to perform price quoting.

In some embodiments, the apparatus (system) and method may have an administration module that may allow a user of one or more types, whether manufacturer, dealer, reseller, or another business entity known to one skilled in the art, to set up product configuration models, product prices, and pricing rules. Some embodiments may include a process that may allow the release of a business entity's setup data for product, product configuration models, and pricing (also herein referred to as “released set up data”). According to some embodiments, in a release process, set up data may be duplicated on the system, so that the original set up data may be changed or updated without affecting the copied set up data, thus providing a stable version (the copy) to be used by partners. Some embodiments may include an administration module enabling users to setup access rights of users affiliated with other business entities (partners) to the released and shared set up data. Some embodiments may include an administration module enabling users to control the manner in which released set up data may be used by the partner users with whom the data has been shared. Some embodiments may allow multiple copies of the released set up data to be made, with each copy of the data secured so that the data may be accessible to users affiliated with one or more specified partner entities. Users with whom released setup data is shared may modify, extend, and/or enhance product, configuration, and price data, or include such data in their own configuration models, according to the rights that may have been granted to them by the sharing partner. Some embodiments may include a module enabling users affiliated with a partner business entity, with whom released set up data has been shared, to in turn release the data that has been shared with them, as well as data they have set up themselves, so that such data may be used in product configuration models and quoting processes.

According to some embodiments, the apparatus (system) and method herein may allow a user to release and share set up data for product configuration models, prices, and pricing rules with other business entities (partners). The apparatus (system) and method herein may control the types of modifications that partners can make to released and shared models and data, or control the ways in which modifications can be incorporated as components in the partner's own product configuration models. The apparatus (system) and method may allow a user to access the released and shared set up data for one more partners' product configuration models, prices, and pricing rules. The apparatus (system) and method may allow a user to modify the released setup data for product configuration models, and/or prices that have been shared by any partner, according to the rights that have been granted to them by the sharing partner(s). The apparatus (system) and method may allow a user to include the product configuration models that may have been shared with them by one or more partners in their own system configuration models. The apparatus (system) and method may allow a user to release runtime configuration models, which may include configuration models and pricing that have been shared with them by one or more partners, as well as their own configuration models and pricing, for use in their own quoting process. The apparatus (system) and method may allow a user to access the product configuration models, prices, and/or pricing rules that have been released by their own affiliated business entity, for use in quoting. The apparatus (system) and method may allow a partner user to release data that has been shared with them, data they have modified, as well as their own data as a product model, so it can be used to create a quote. The apparatus (system) and method may allow a partner user to access the product configuration models, prices and/or rules that they have released, so that the released product models may be used to create a quote that includes both modified and unmodified product configurations that have been shared with them by partners, as well as on their own configuration models.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-B are a flowcharts of example CPQ methods, according to some embodiments.

FIG. 2 depicts an existing CPQ system and how a reseller may use the existing CPQ system to obtain configuration price quotes.

FIG. 3 depicts a CPQ system and how a reseller may use the CPQ system to obtain configuration price quotes, according to some embodiments.

FIG. 4 depicts an existing CPQ method of how an integrator may use the existing CPQ system to obtain configuration price quotes.

FIG. 5 depicts a CPQ system and how a dealer or integrator may use the CPQ system to obtain configuration price quotes, according to some embodiments.

FIG. 6 illustrates a computer network system or similar digital processing environment, according to some embodiments.

FIG. 7 illustrates a diagram of an example internal structure of a computer (e.g., client processor/device or server computers) in the computer network system of FIG. 6, according to some embodiments.

### DETAILED DESCRIPTION OF THE INVENTION

A description of example embodiments of the invention follows.

The teachings of all patents, published applications and references cited herein are incorporated by reference in their entirety.

CPQ systems (also considered to apply to CPQ methods and/or CPQ apparatus herein) may be used by manufacturers to offer configurable products to their customers. However, many enterprises resell or integrate products manufactured by other companies.

However, for resellers and integrators, CPQ systems may have limited practical usefulness. CPQ systems may be used to configure, price, and/or quote complex products. In order to configure, price, and/or quote a given product, a CQP system may first be set up with product data, pricing data, and/or configuration rules that may govern how the given product may be configured.

According to some embodiments, configuration rules may be specialized and/or complex. The rules may change over time as the manufacturer may release different versions of their products. Therefore, in existing systems, it may be challenging for an enterprise (e.g., company) other than the manufacturer itself to set up, deploy, and/or maintain a CPQ system for that manufacturer's products.

Furthermore, resellers may often sell products from not just one manufacturer, but many manufacturers. The burden of maintaining product configuration data and configuration rules for many products from several manufacturers may be prohibitively difficult for most resellers.

In existing approaches, such configuration rules may be understood by the product manufacturer. However, in stark contrast, some embodiments of the present invention are not so limited, and in some embodiments, configuration rules may be accessed by other product manufacturers, other divisions within the same company that a business entity belongs to, and/or other users, including but not limited to partner users, which may include but are not limited to resellers, integrators, and/or dealers.

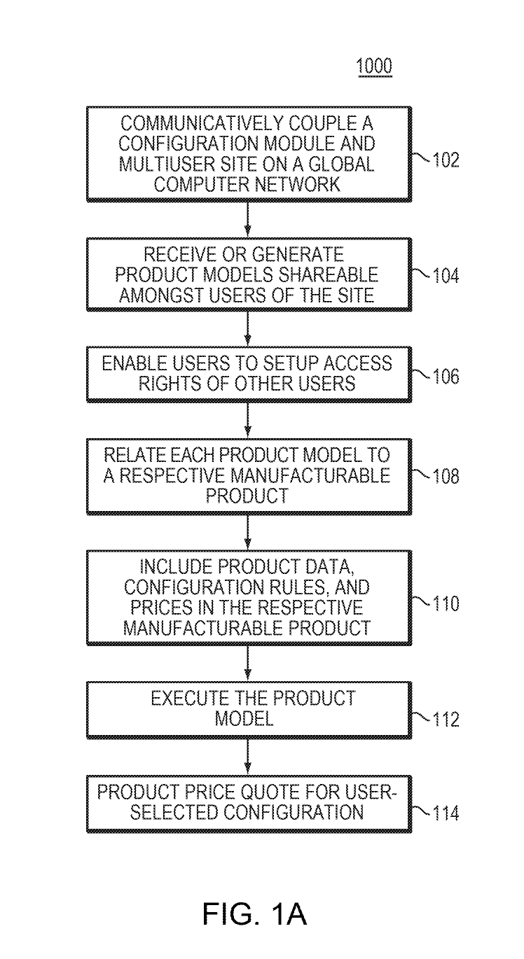

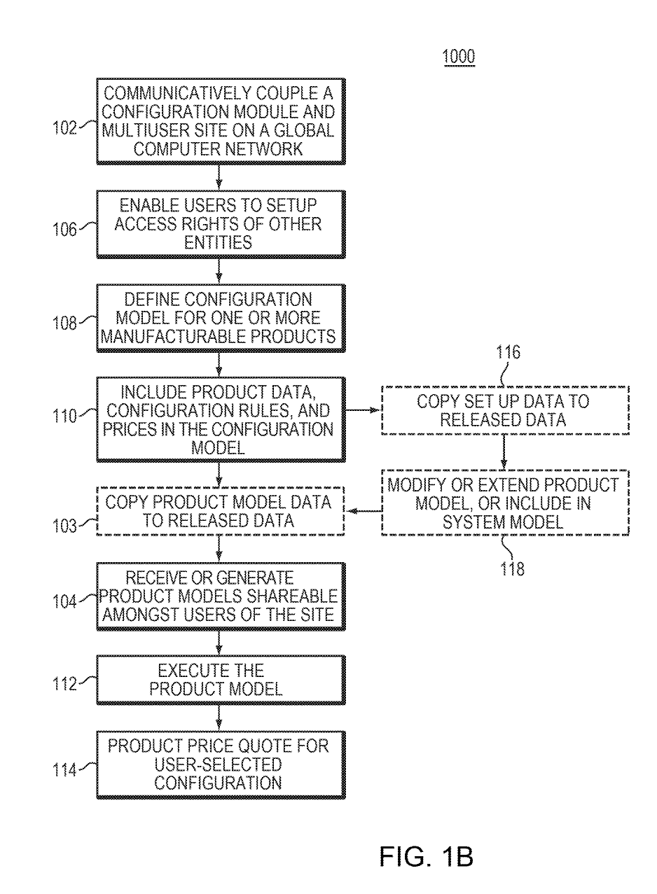

FIG. 1A is a flowchart of an example CPQ method, according to embodiments of the present invention/Existing systems fail to provide configuration-price-quoting in a shareable manner across multiple sites with multiple users. The disclosed apparatuses, systems, and methods address these deficiencies of existing systems. As such, according to some embodiments, as illustrated in FIG. 1A, a method (and apparatus) 1000 may provide configuration-price-quoting in a shareable manner across multiple sites with multiple users. Some embodiments may include a configuration module and communicatively couple the configuration module and multiuser site on a global computer network 102. Some embodiments may generate product models from released data for a multiuser site 104. The received (or generated or accessed) released product models may be shareable amongst users of the multiuser site. Embodiments may include an administration module that may enable the users to setup access rights of other users to the received (or generated or accessed) released product models, such that different users may have (same or different) access rights to different (or the same) received (or generated or accessed) released product models of other users in addition to the other users' own received (or generated or accessed) released product models. 106. Each received (or generated or accessed) product model may relate to one or more respective manufacturable products 108. Each received (or generated or accessed) product may include product data of the manufacturable product, configuration rules, and/or prices for the manufacturable product 110. A user with access rights to the received (or generated or accessed) released product models from one or more partners may execute the received (or generated or accessed) released product model 112 to produce a certain price quote for a user-selected configuration of the corresponding manufacturable product or service 114.

FIG. 1B is a flowchart of an example CPQ method, according to embodiments of the present invention. According to some embodiments, as illustrated in FIG. 1B, a method (and apparatus) 1000 may provide configuration-price-quoting in a shareable manner across multiple sites with multiple users. Some embodiments may include a configuration module and communicatively couple the configuration module and multiuser site on a global computer network 102. As illustrated in FIG. 1B, some embodiments may allow product model data to be copied as a set of released data, so that original data may subsequently modified while the copied data may be used for runtime quoting 103. Embodiments may include an administration module that may enable the users to setup access rights of other users to the received (or generated or accessed) released product models, such that different users may have (same or different) access rights to different (or the same) received (or generated or accessed) released product models of other users in addition to the other users' own received (or generated or accessed) released product models 106. Each received (or generated or accessed) product model may relate to one or more respective manufacturable products 108. Each received (or generated or accessed) product may include product data of the manufacturable product, configuration rules, and/or prices for the manufacturable product 110. Optionally, configuration model set up data may be copied and shared 116, so that resellers can modify or extend a partner manufacturer's configuration models, or include them in system models of their own 118. Optionally, some embodiments may allow product model data to be copied as a set of released data, so that original data may subsequently modified while the copied data may be used for runtime quoting 103. Some embodiments may generate product models from released data for a multiuser site. The received (or generated or accessed) released product models may be shareable amongst users of the multiuser site 104. A user with access rights to the received (or generated or accessed) released product models from one or more partners may execute the received (or generated or accessed) released product model 112 to produce a certain price quote for a user-selected configuration of the corresponding manufacturable product or service 114.

In some embodiments of the method (and apparatus) 1000, the user may have access rights including but not limited to access rights to the received (or generated or accessed) released product models. The user may further execute the received (or generated or accessed) released product model to access (or select, or define, or create) one or more (e.g., single or multiple) configurations of the corresponding manufacturable product or service. The user may include at least one of a manufacturer user and a partner user. The partner user may be at least one of a reseller, an integrator, and a dealer, or any other business entity. The manufacturer user may access the administration module to release certain product data, configuration rules, pricing, and pricing rules. The manufacturer user may access the administration module to indicate, with respect to the other users, access to the received (or generated or accessed) released product models. The partner user may access the received (or generated or accessed) released product models and the partner user may execute the released product model to perform price quoting.

The apparatus (system) and method 1000 may have a module that allows a user of any type, whether manufacturer, dealer, reseller, or another business entity known to one skilled in the art, to set up product configuration models, product prices, and pricing rules. Some embodiments may include a process that allows the release of some of a business entity's set up data for products, product configuration models, and pricing (also herein referred to as “released set up data”). In a release, set up data may be duplicated on the system, so that the original set up data may be changed or updated without affecting the copied set up data, thus providing a stable version (the released copy) to be used by partners. Some embodiments may include an administration module enabling users to setup access rights of users affiliated with other business entities (partners) to their released and shared product, configuration, and price set up data. Some embodiments may include an administration module enabling users to control the manner in which released set up data may be used by the partner users with whom the data has been shared. Some embodiments may allow multiple copies of the released set up data to be made, with each copy of the data secured so that it is only accessible to users affiliated with one or more specified partner entities. Some embodiments may include a module enabling users with whom released setup data has been shared (i.e., resellers, dealers, or integrators) to modify, extend, or enhance product, configuration, and price data, or include such data in their own configuration models, according to the rights that have been granted to them by the sharing partner. Some embodiments may include a module enabling users affiliated with a partner business entity, with whom released set up data has been shared, to in turn release the data that has been shared with them, as well as data they have set up themselves, so that such data may be used in product configuration models and quoting processes of their own. The apparatus (system) and method 1000 may allow a user to release and share set up data for product configuration models, prices, and pricing rules with other business entities (partners). The apparatus (system) and method 1000 may control or limit the types of modifications that partners can make to released and shared models and data, or control the ways in which they can be incorporated as components in the partner's own product configuration models. The apparatus (system) and method 1000 may allow a user to access the released and/or shared set up data for a partner's product configuration models, prices, and pricing rules. The apparatus (system) and method 1000 may allow a user to modify the released setup data for product configuration models, prices, and pricing rules that have been shared by any partner. The apparatus (system) and method 1000 may allow a user to include the product configuration models that have been shared with them by one or more partners in their own configuration models. The apparatus (system) and method 1000 may allow a user to release runtime configuration models, which may include configuration models and pricing that have been shared with them by one or more partners, as well as their own configuration models and pricing, for use in their own quoting process. The apparatus (system) and method 1000 may allow a user to access the product configuration models, prices and rules that have been released by their own affiliated business entity for use in quoting.

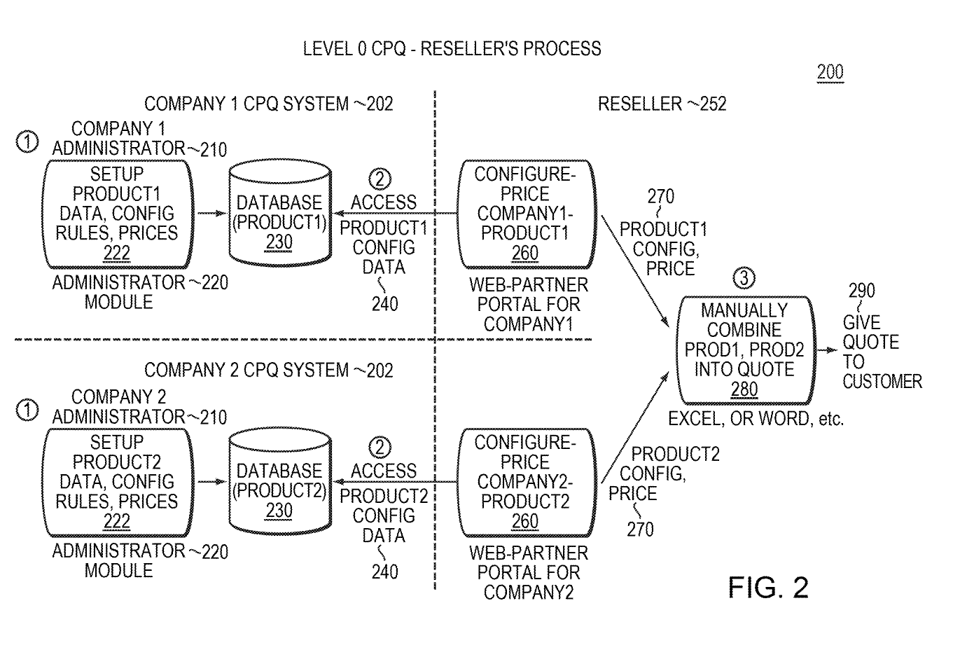

FIG. 2 depicts an existing CPQ system (and method) and how a reseller may use the existing CPQ system to configure, price, and/or quote products. Some embodiments may include one or more portions (or all portions of) the existing system (and method) of FIG. 2. As illustrated in the existing system (and method) 200 of FIG. 2, companies may provide CPQ systems 202 in which administrators 210 perform setup 222 of product data, configuration rules, and/or prices through administration modules 220, which in turn provide the product data, configuration rules, and prices to databases (e.g., product databases) 230. As illustrated in the existing system (and method) 200 of FIG. 2, a reseller 252 may provide a quote to a customer 290 by manually combining 280 product configuration and/or pricing information 270 that may be provided through company web-partner portals 260. Existing company web-partner portals 260 may provide limited product configuration and price information through limited access 240 to databases 230, and may not provide access to product models, however, some embodiments are not so limited.

Dealers and/or integrators may include resellers who sell solutions that may include modified or multiple products. Dealers and/or integrators may desire to modify or extend product configurations, and/or combine them into an integrated system. Usually, there are system-level configuration rules that may apply to the relationships between products in a configured system. In a simple non-limiting example for a home entertainment system including a television (TV) and a Digital Video Disc (DVD) player, the TV may preferably require a certain type of input cable. The DVD player may support the same type of cable in order to connect and send its signal to the TV. A CPQ system (or computer application) which quotes a system including this TV and DVD player may embody a rule that may ensure that the TV and DVD are compatible (i.e., by ensuring that the TV and DVD each support the same type of DVD-TV input cable), and that the correct type of interface cable is included in the apparatus (system) and method 1000. Some CPQ systems are powerful enough to allow the definition of system-level configuration rules, and are used by integrators to quote configurable systems that include various products. However, in existing approaches, when the products themselves are configurable, and they often are, dealers and integrators may have the same challenges as other resellers. In existing approaches, setting up configuration rules for products that are manufactured by other companies may not be not feasible. The disclosed apparatuses, systems, and methods overcome the challenges of existing systems by providing access (and/or setup) to different configuration rules across different products and/or across different companies.

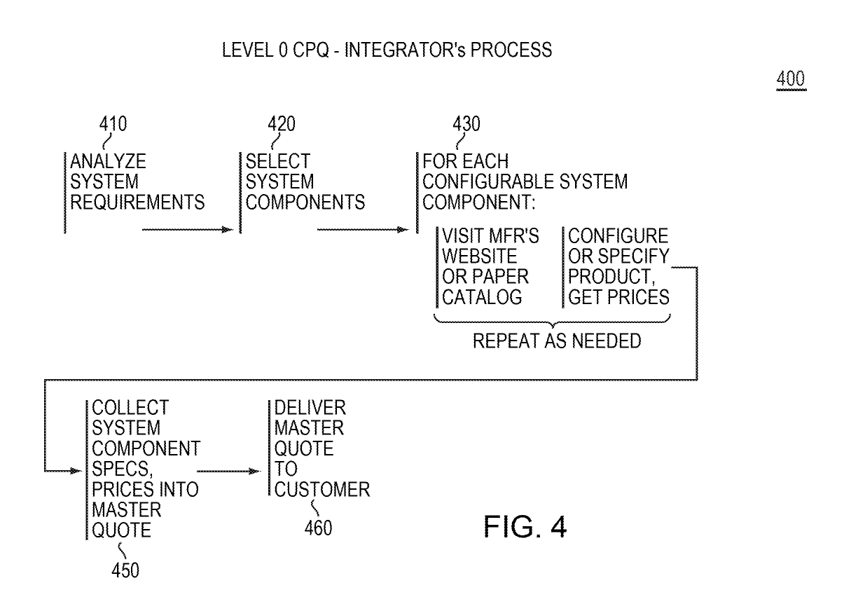

FIG. 4 depicts an existing CPQ system (and method) 400 and how an integrator may use the existing CPQ system to obtain configuration price quotes. Some embodiments may include one or more portions (or all portions of) the existing system (and method) of FIG. 4.

As illustrated in FIG. 4, an integrator 452 may deliver a master quote for a system configuration to a customer 460 by collecting system configuration information (including but not limited to various product components, specifications, and/or prices) from multiple components 450. The integrator 452 may first analyze overall system requirements 410, and then select system components 420. After selecting system components 420, the integrator 452 may collect component information 450 by manually (and iteratively, for each component of the system) visiting a manufacturer's website or catalog, and configuring or specifying the product to obtain prices, until a desired system configuration is achieved 430. Then, after collecting component information 450, the integrator 452 may manually deliver a master quote for a system configuration to a customer 460.

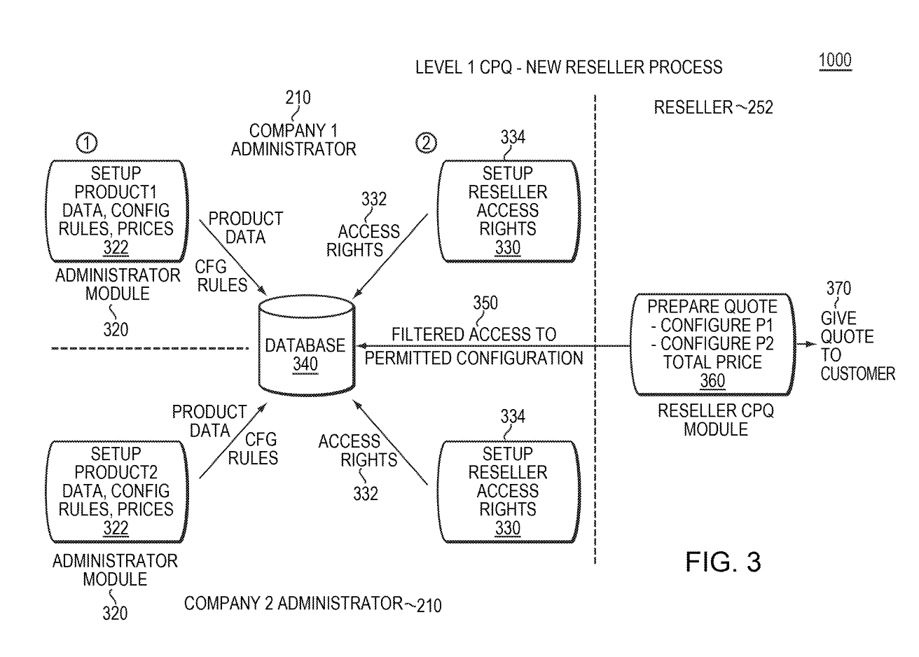

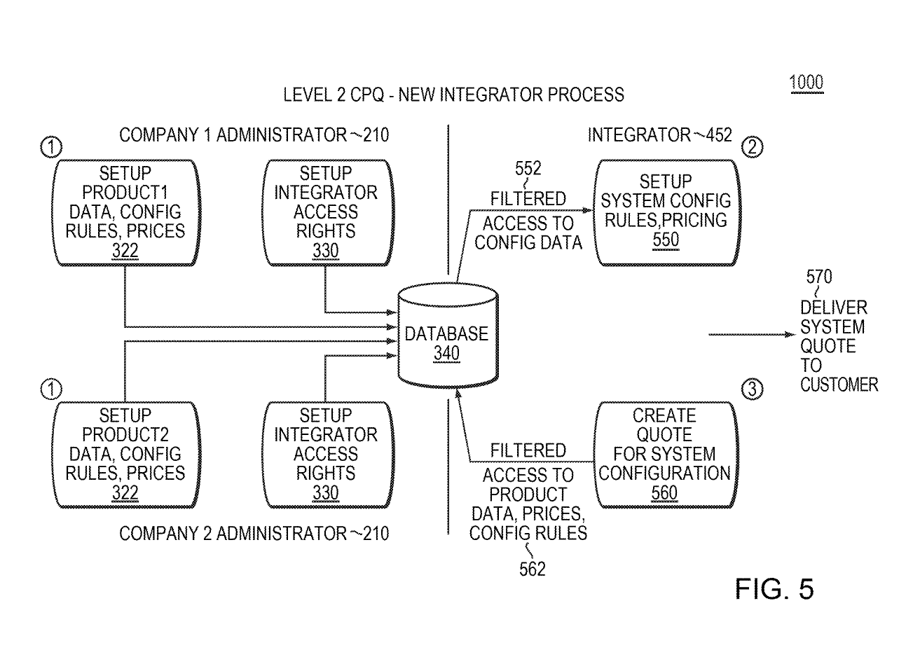

As illustrated in FIGS. 3 and 5 to follow, some embodiments may solve the problems encountered by one or more of the following types of parties: manufacturers, resellers, dealers, and integrators. According to some embodiments, services may also be configurable, and the CPQ system (and method, and apparatus) may handle configurable services in the same way that it handles products. Herein, the term “product configuration” includes both service and product configurations. Products may be sourced from manufacturers, while services may be sourced from service providers. Herein the term “manufacturer” is used to apply to both manufacturers (of products) and service providers (of services). The CPQ system (and apparatus, and method) described herein may support the needs of manufacturers, as well as the needs of resellers, integrators, and/or dealers. The CPQ system (and apparatus, and method) may allow more than one enterprise to set up and share product configuration rules and prices with partner business entities, which in turn may allow a user to include configured products from more than one company in a single sales quotation.

In addition to the existing base approaches of FIGS. 2 and 4, which are current practice, two innovative approaches are described, as illustrated in FIGS. 3, and 5, according to some embodiments. The existing base approaches of FIGS. 2 and 4, also known as “CPQ Level 0 for Single-enterprise Administration of Product Configuration,” includes a CPQ system (and method and apparatus) that may allow an enterprise or an enterprise's agents to setup configurable products for sale. This functionality is typical of existing CPQ software programs and is described herein to provide background information.

According to some embodiments, FIG. 3 illustrates a novel innovation, known as “CPQ Level 1 for Resellers” that may include a CPQ system (and apparatus, and method) that allows configurable products to be setup in the system by multiple enterprises, so the products from more than one enterprise may be offered on a single sales quotation, and so configurable products may be easily offered by partners. According to some embodiments, it is assumed there may be no configuration relationship between the products on the quotation.

According to some embodiments, FIG. 3 depicts a CPQ system (and method) 1000 and how a reseller may use the novel CPQ system to obtain configuration price quotes. According to some embodiments, as illustrated in the CPQ system (and apparatus, and method) 1000 of FIG. 3, companies may provide CPQ systems in which administrators 210 may setup and release 322 product data, configuration rules, and/or prices through administration modules 320, which in turn may provide the released product data, configuration rules, and/or prices to a unified database 340. The released data may be used by in a quote by sales user 215, who is affiliated with entity 210, and also by reseller 252. As illustrated in FIG. 3, a reseller 252 may provide a quote to a customer 370 by preparing price quotes for various product configurations 360 (and a total or aggregate price) based upon the reseller's filtered access 350 to permitted configurable products stored in the database 340. Filtered access 350 may include products that may have been released and shared by partner 210 and also by reseller 252 themselves. The company administrators 210 may selectively setup (or filter or permit) 330 access rights 332 for the reseller through one or more administration modules 334, in order to determine which configurable products the reseller is permitted to access.

Next, according to some embodiments, FIG. 5 depicts a CPQ system (and method) and how a dealer or integrator may use the existing CPQ system to obtain configuration price quotes.

FIG. 5 illustrates a novel innovation, known as “CPQ Level 2 for Dealers or Integrators” that may include a CPQ system (and apparatus, and method), which may enable a sales quotation for configured products that may be modified or extended by a dealer, or a sales quotation for configured systems, which in turn may be made of products that may be, themselves, configured. Some embodiments may allow configured products to be setup by the manufacturer, and then released and shared so the configuration set ups may be modified or extended by a dealer and/or integrator, to include changes or additions to the product and pricing that may be provided by the dealer and/or integrator. Some embodiments may allow configured products to be setup by multiple enterprises, so that configurable products from more than one enterprise may be offered as part of a configured system, and may be included on a single sales quotation.

According to some embodiments, as illustrated in the system (and method) 1000 of FIG. 5, companies may provide CPQ systems in which administrators 210 may setup, release and share the setup data for products, product data, configuration rules, and/or prices 322 through administration modules (not shown in FIG. 5), which in turn may provide the released setup data for products, product data, configuration rules, and/or prices to a unified database 340.

In other words, as illustrated in the CPQ system (and apparatus, and method) 1000 of FIG. 5, companies may provide CPQ systems in which administrators 210 may setup and release 322 product data, configuration rules, and/or prices through administration modules (not shown in FIG. 5), which in turn may provide the released product data, configuration rules, and/or prices to a unified database 340.

As illustrated in FIG. 5, an integrator 452 may deliver a system quote 570 to a customer, and the system quote may include one or more individual configured products such as those sold by resellers, modified products, and configured systems, which may in turn include sub-configurations of multiple configurable components. The integrator 452 may create a quote for various system configurations 560 based upon filtered access to released and/or shared product data, prices, and/or configuration rules 562 stored in the database. The filtered access to the dealers/integrators may be setup 330 by administrators 210 through administration modules (not shown in FIG. 5). Similarly, the dealer/integrator 452 may receive access to shared and released product data, prices, and/or configuration rules 552 in order to create 550 a customer quote, which may include any of: configured products such as those sold by resellers, dealer modified products, or configured systems, which may in turn include configurations of multiple configurable components. The dealer's and/or integrator's access to the product models may be setup 330 (e.g., determined) by the administrators 210.

Referring back to FIG. 2 and FIG. 4, a description is provided herein regarding existing approaches, otherwise known as “CPQ Level 0” approaches. Some embodiments may include one or more features and/or functions (and/or one or more portions) of “CPQ Level 0” approaches.

CPQ Level 0 for Single-Enterprise Administration of Product Configuration.

CPQ Level 0 for single enterprise may include an existing system from industry. CPQ Level 0 system may include a system database, which may include a list of sellable products, product configuration rules, pricelists, pricing rules, and/or systems permissions. CPQ Level 0 also may enable a configured product set up function, by which sellable products may be defined in the system database, and product configuration rules may be programmed. The list of sellable products may include the seller's own manufactured products as well as products made by others, which may be resold by that seller. For one or more products that may be configurable (regardless of who manufacturers the product), the administrator may program rules governing product configuration.

The CPQ Level 0 system may enable a price and/or pricing rule set up function, which may allow the setup of item prices and/or pricing rules. Pricing rules may adjust prices in the context of a quote, subject to one or more factors, including but not limited to item quantity, buyer location, presence of other products in the quote, and other factors known to one skilled in the art. The CPQ Level 0 system may enable a sales quotation function which may allow the user to create a quote, identify the buyer, add one or more products to the quote as quote line items, launch the configurator for configurable products, and/or acquire, display and/or tally the prices for the product line items. The sales quotation may also include various commercial terms including product availability, shipping charges, and other terms known to those skilled in the art.

The CPQ Level 0 system may also enable a product discovery function, which may allow the user to search for products and/or add them to the product quotation. The system may enable a product configuration function, which may present one or more options for a configurable product to the user, so the user can define their desired configuration. The configuration function may enforce configuration rules that may govern which options the user may select. The CPQ Level 0 system may execute a pricing function that may determine the price of each product for the customer who is the purchasing party on the quote (e.g., product quote).

According to some embodiments, a CPQ Level 0 system may allow configurable products from multiple enterprises to be setup, and then quoted. However, a CPQ Level 0 system is operated solely by the business entity that sells the products, who must assume the burden of understanding and programming product configuration rules. If the products are not manufactured by the selling entity, this is commercially impractical since the rules may be complex, and frequently change over time as the products' manufacturer introduces new products or product changes.

Embodiments illustrated in FIG. 3 and FIG. 5 may include a configure-price-quote (“CPQ”) software application, which may allow the user to include configured products from more than one enterprise in a single sales quotation. As such, some embodiments may address the challenges (and overcome the limitations) of existing CPQ systems which may limit the ability of product resellers, dealers, and integrators to configure and/or quote their partners' products. Some embodiments include at least two innovative approaches that may be implemented as CPQ systems, CPQ method, or CPQ apparatus.

As illustrated in FIG. 3, in one innovative approach (“CPQ Level 1 for Resellers”), a new variation on CPQ software (or a CPQ application, or a CPQ computer application) may allow multiple enterprises to setup their configurable products, which in turn may allow products from multiple providers to be located and placed on a single reseller's quotation. In some embodiments, there may be no configuration relationship between the products on the quotation.

As illustrated in FIG. 5, in a second innovative approach (“CPQ Level 2 for Dealers and/or Integrators”), the CPQ system (and apparatus, and method) may allow product configurations to be modified by the partner, and/or to include them in configured systems, one or more of which may then be quoted. According to some embodiments, configured products may be setup by one more enterprises, and the products may then be extended or modified, or combined into a configurable system by a different enterprise.

CPQ Level 1 for Reseller.

As illustrated in FIG. 3, a CPQ system may support the requirements of single-enterprise administration, as in CPQ Level 0 system, but also enable resellers to configure and quote the products of their partners.

FIG. 3 shows how a reseller may use a CPQ system (and apparatus, and method) 1000, according to some embodiments. The CPQ Level 1 for Resellers may include a system database 340 which may include a list of sellable products, product configuration rules, pricelists, pricing rules, and/or systems permissions. As illustrated in FIG. 3, in addition to the data to satisfy the requirements for a CPQ Level 0 system, the database 340 also may include a list of enterprises who may use the system, as well as data that may identify the rights that each enterprise may have to view or otherwise interact with their partners' product and pricing data. Some embodiments may be able to manage Partner Access Rights (e.g, rights of one or more partners to access one or more product models). Partner Access Rights may enable an enterprise to identify which of its partner resellers may resell its sellable product. A security feature may ensure that each seller may view, interact with, or otherwise incorporate a partner's product data within a given function available in the CPQ system (and apparatus, and method) 1000.

As illustrated in FIG. 3, the CPQ system (and apparatus, and method) 1000 may provide a configured product setup 322 through an administration module 320 by multiple manufacturing enterprises (or administrators 210). This may allow one or more manufacturers to define their own configurable products and/or corresponding product configuration rules in the CPQ system (and apparatus, and method) 1000. A security function (not depicted in FIG. 3) may ensure that each manufacturer may see and interact with its own product configuration data. Reseller partners 252 may be given access to view or otherwise interact with a manufacturer's product and/or configuration data at the discretion of the manufacturer.

As illustrated in FIG. 3, the CPQ system (and apparatus, and method) 1000 may provide price and/or pricing rule setup for multiple sourcing enterprises (manufacturers or service providers). This may allow the setup 322 of item prices and pricing rules for each manufacturer's own products. Item prices (pricelists) and/or pricing rules may be set up 322 that are targeted to each manufacturer's own customers, but also may be setup 322 with pricelists and pricing rules that may apply to specific reseller-partners A security function (not shown in FIG. 3) may ensure that each enterprise may manage its own pricing data, but resellers may see prices that are being offered by their manufacturer partners to them. The CPQ system (and apparatus, and method) 1000 may enable a reseller to setup prices and/or pricing rules. This may allow resellers to define their own pricing for a manufacturer's products which they may resell to their own customers.

The CPQ system (and apparatus, and method) 1000 may enable a sales quotation function which may allow the user to create a quote, identify the buyer, add one or more products to the quote, launch the configurator for configurable products, and/or acquire the price for the product. The system may execute a product discovery function which may allow products from multiple enterprises to be discovered and/or added as line items to the quotation. The product discovery function may implement a security feature which may ensure that sellers may access both their own products and/or product data for which they are granted access by their partners. As such, enterprises may access products which they, themselves have defined in the system, but may not be able to access the products and product information set up by other enterprises unless they are granted access.

The CPQ system (and apparatus, and method) 1000 may execute a product configuration function, which may present one or more options for a configurable product to the user, so the user can define their desired configuration. The configuration function may enforce configuration rules that may govern which options of the configurable product the user may pick.

The CPQ system (and apparatus, and method) 1000 may execute a pricing function that may determine the price of each product for the customer who is the purchasing party on the quote. Note that these prices may include prices that sellers and/or resellers offer to their own customers.

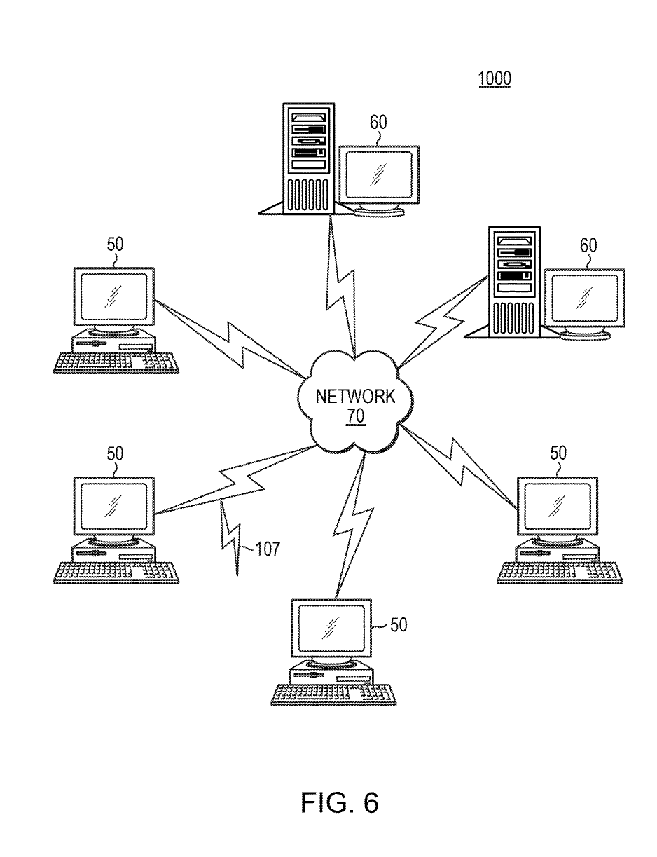

In addition, the CPQ system (and apparatus, and method) 1000 may be connected to a network (e.g. the “internet” as illustrated in FIG. 6) so that the CPQ system (and apparatus, and method) 1000 may be accessible by users of a participating enterprise, regardless of location.

Implementation: CPQ Level 1.

Next, as illustrated in FIG. 3, the CPQ system (and apparatus, and method) 1000 may be accessible by participating companies regardless of their location (for non-limiting example, over the “internet” as illustrated in FIG. 6 to follow). The CPQ system (and apparatus, and method) 1000 system may include a data storage service (“database”) that may include one or more of the following data elements, including but not limited to a list of companies, a list of users, a list of commercial relationships, a list of enterprise products, a set of product configuration model data, a list of pricing data, a set of released configuration data, a set of released pricing data, a list of product-reseller rights

The CPQ system (and apparatus, and method) 1000 may include a list of companies authorized to use the system and participate in commercial processes with other companies also using the CPQ system (and apparatus, and method) 1000:

Below is a non-limiting example table of a List of Companies:

Entity
Enterprise1
Enterprise2
Enterprise3

Below is a non-limiting example table of a list of users who are authorized to access the system, and the company with whom the user is affiliated:

Non-Limiting Example List of Users:

| Entity | User |
|---|---|
| Enterprise1 | User1-1 |
| Enterprise1 | User1-2 |
| Enterprise2 | User2-1 |
| Enterprise3 | User3-1 |

Below is a non-limiting example list that includes a list of pair-wise commercial relationships between companies, identifying the names of each company and the nature of the relationship.

Non-Limiting Example List of Commercial Relationships

| Entity | Commercial Relationship | Partner |
|---|---|---|
| Enterprise1 | Sells wholesale products to | Enterprise3 |
| Enterprise2 | Sells wholesale products to | Enterprise3 |

Below is a non-limiting example list that includes a list of products offered by each enterprise, as a list of enterprise-product associations.

Non-Limiting Example List of Enterprise Products:

| Entity | Product |
|---|---|
| Enterprise1 | Product1-1 |
| Enterprise1 | Product1-2 |
| Enterprise2 | Product2-1 |
| Enterprise3 | Product3-1 |

Below is a non-limiting example list that includes a list of access rights granted to partner-companies in a given company's trading network (“Reseller-Product Rights”). According to some embodiments, this could be an implied relationship. In some embodiments, the access rights are explicitly stated.

Non-Limiting Example List of Product-Reseller Rights:

| Entity | Products Resold | Partner |
|---|---|---|
| Enterprise1 | Product1-1 | Enterprise3 |
| Enterprise2 | Product2-1 | Enterprise3 |

In some embodiments, access rights may be stated at the company-company level, implying rights to resell one or more products. For non-limiting Example: Enterprise2 may be a reseller for Enterprise1 (implying one or more products of Enterprise1).

According to some embodiments, reseller rights may be implied by other data, for non-limiting example because of the presence of a pricing list. For non-limiting Example: Enterprise1 may create a pricing list called “Enterprise2 Reseller Pricelist,” which may include a product “Product1-1” at a price of $1.00, thereby implying that Enterprise2 may resell Product1-1.

According to some embodiments, a list of Product Prices, each of which may be designated for a particular Company, may be part of table design. For non-limiting example, the same product could be sold from Enterprise1 to Enterprise3 at price X, and that same product could then be sold by Enterprise3 to Customer1 for price Y.

Non-Limiting Example List of Product Prices:

| Entity | Product | Buyer | Price |
|---|---|---|---|
| Enterprise1 | Product1-1 | Enterprise3 | $10,000.00 |
| Enterprise2 | Product2-1 | Enterprise3 | $15,000.00 |
| Enterprise3 | Product1-1 | US Customers | $13,500.00 |
| Enterprise3 | Product2-1 | US Customers | $17,500.00 |

Some embodiments may include a set of data defining product configuration rules for each configurable product to be offered by a given company. Some embodiments may include a set of data defining released product pricing data:

### Non-Limiting Example List of Released Product Prices:

| Release | Entity | Product | Buyer | Price |
|---|---|---|---|---|
| V1.1 | Enterprise1 | Product1-1 | Enterprise3 | $10,000.00 |
| V1.1 | Enterprise2 | Product2-1 | Enterprise3 | $15,000.00 |
| V1.1 | Enterprise3 | Product1-1 | US Customers | $13,500.00 |
| V1.1 | Enterprise3 | Product2-1 | US Customers | $17,500.00 |

An administration component may allow an agent for any participating company to define product configuration rules and/or data, identify presence and nature of relationships with other participating companies, assign rights for partner companies to resell one's (e.g., a user's) products, either explicitly or implicitly as noted above, create product prices for one's customers, and/or create reseller prices for one's reseller partners.

The CPQ system (and apparatus, and method) 1000 may include a Sales Quotation component that may allow a user to perform one or more of the following actions: create a sales quotation, identify the customer (buyer), specify commercial terms and/or add products to the quotation, while enforcing Reseller-Product Rights and enforce configuration rules for configurable products. According to some embodiments, no agent of any company may see or otherwise interact with product information in the system database for which that user's company has not been granted the right (e.g., access right) to resell, either implicitly or explicitly.

Operation of the System and Component Behavior.

For non-limiting example, the CPQ system (and apparatus, and method) 1000 may assume that data is populated in its database 340 for companies called Enterprise1 and Enterprise2, with corresponding Users User1-1, User1-2, and User2-1. For non-limiting example, the CPQ system (and apparatus, and method) 1000 may assume that product and configuration data is populated in the Database for Product1-1, Product1-2, and Product2-1. For non-limiting example, the CPQ system (and apparatus, and method) 1000 may assume that Product Configuration rules are setup for Product1-2 and Product2-1.

According to some embodiments, for non-limiting example, in the CPQ system (and apparatus, and method) 1000, new company Enterprise3 may wish to participate in commercial activity with Enterprise1 and Enterprise2. Enterprise3 may be a reseller, selling product manufactured by Enterprise1 and Enterprise 2. According to some embodiments, for non-limiting example, in the CPQ system (and apparatus, and method) 1000, the following entries may be entered into the database, to set up Enterprise 3:
1. [System Administrator] Add Enterprise3 to the List of Companies.
2. [Enterprise3 Administrator] Add User3-1 to the List of Users.
3. [Enterprise1 Administrator] Add “Enterprise1—Sells Wholesale Products To—Enterprise3” to the List of Commercial Relationships.
4. [Enterprise2 Administrator] “Enterprise2—Sells Wholesales Products To—Enterprise3” to the List of Commercial Relationships.
5. [Enterprise1 Admin] Add “Enterprise1, Product1-1, Enterprise3” to the List of Product Reseller Rights, making product 1-1 available for resale to Enterprise3.
6. [Enterprise2 Admin], Add “Enterprise2, Product2-1, Enterprise3,” to the List of Product Reseller Rights, making product 2-1 available for resale to Enterprise3.
7. [Enterprise1 Admin] Release a version of product and configuration data for use by some users, including Enterprise3.
8. [Enterprise2 Admin] Release a version of product and configuration data for use by some users, including Enterprise3.
9. [Enterprise1 Admin], Add the following data to the Product Price List: “Enterprise1, Product1-1, Enterprise3, $10,000”.
10. [Enterprise2 Admin], Add the following data to the Product Price List: “Enterprise2, Product2-1, Enterprise3, $15,000”
11. [Enterprise3 Admin], Add the following data to the Product Price List: “Enterprise3, Product1-1, US Customers, $13,500” and “Enterprise3, Product2-1, US Customers,” “$17,500,” which sets up Product1-1 and Product2-1 for sale to any Enterprise3 customer in the United States.

Agents of Enterprise3 may now use the system to prepare sales quotations for their customers. User3-1 may log into the CPQ system (and apparatus, and method) 1000. The CPQ system (and apparatus, and method) 1000 may process the login, look up User3-1, and may identify User3-1 as affiliated with Enterprise3. User3-1 may create a new Sales Quotation. The Sales Quotation module may provide a mechanism for the user to add Products to the Quote. The mechanism may check the List of Product-Reseller Rights in the Database, to determine which Products agents of Enterprise3 are permitted to access. In this example, Product1-1 and Product2-1 may be available to Enterprise3, and User3-1 may add either or both to the Quote. User3-1 may configure the Products. When configuration is complete, the Prices for the Products may be shown in the Quote.

CPQ Level 2 for Dealers and/or Integrators.

As illustrated in FIG. 5, according to some embodiments, the CPQ system (and apparatus, and method) 1000 may support the requirements of single-enterprise administration, as in CPQ Level 0, the requirements of Resellers as in CPQ Level 1, and/or also enable resellers, dealers, or integrators to extend, modify, or enhance configuration models, or to include them in their own configurable system models. Some embodiments of the CPQ system (and apparatus, and method) 1000 may enable configuration of products in which the configuration has been modified or extended by the reseller, in order to support product changes or additions that may be provided by the reseller. Some embodiments of the CPQ system (and apparatus, and method) 1000 may enable quoting that may include any of individual configured products such as those sold by resellers, modified products, and configured systems, which may in turn include sub-configurations of multiple configurable components.

According to some embodiments, FIG. 5 shows how a dealer or integrator may use the CPQ system (and apparatus, and method) 1000. As illustrated in FIG. 5, the CPQ system (and apparatus, and method) 1000 may include a System Database 340, which may include a list of sellable products, product configuration rules, pricelists, pricing rules, and/or systems permissions. In addition to data to satisfy the requirements for CPQ Level 0, the database 340 also may include a list of enterprises who may use the system, as well as data that may identify the rights that each enterprise has to view or otherwise interact with their partners' data. To support dealers and integrators for Level 2, the database 340 may keep track of product, configuration, and pricing setup data that has been released and shared by partners, as well as the modifications or extensions to configurations models to such data made by dealers/integrators. The database 340 may also keep track of systems models created by integrators, which may include configuration rules governing how various components of the system must interact, as well as released configuration models that have been shared by partners. The database 340 may also keep track of product, configuration, and pricing data versions that dealers/integrators may release for use by their own affiliated users in the creation of quotes that include their own configurable products, products that have been shared with them, which may or may not have been modified by the dealer/intergrator, as well as systems models which may include configurable products. The CPQ system (and apparatus, and method) 1000 may manage Partner Access Rights. As such, the CPQ system (and apparatus, and method) 1000 may enable an enterprise to identify which of its partner resellers may resell its sellable product. A security feature may ensures that each seller may view, interact with, modify, or otherwise incorporate a partner's released and shared product data within any function available in the CPQ system (and apparatus, and method) 1000. The CPQ system (and apparatus, and method) 1000 may enable configured product setup for multiple selling enterprises. This may allow for one or more enterprises to define their own sellable products and/or corresponding product configuration rules in the CPQ system (and apparatus, and method) 1000. A security function (not shown in FIG. 5) may ensure that each enterprise may see and interact with its own product configuration data. Reseller partners 252 may be given access to view or otherwise interact with a manufacturer's product and/or configuration data at the discretion of the manufacturer by the CPQ system (and apparatus, and method) 1000.

The CPQ system (and apparatus, and method) 1000 may allow resellers, dealers, or integrators to extend, modify, or enhance the configuration models, prices, and pricing rules that have been released by their partners and shared with them. The CPQ system (and apparatus, and method) 1000 may allow integrators to define system-level configuration rules. System-level configuration rules may apply to components in an integrated system (such as a home entertainment system, or an enterprise network system, or a specialized truck with various accessories like a winch, a bed-mounted lift, and so on). The components of the system could be non-configurable parts, or they could be configurable products themselves. This may allow integrators to define systems configuration models that contain system-level rules and which may include configurable products that have been setup, released, and shared by their partners. The CPQ system (and apparatus, and method) 1000 may enable price and/or pricing rule setup for multiple sourcing enterprises. This may allow the setup of item prices and/or pricing rules by any number of enterprises. Item prices (pricelists) and pricing rules may be set up that are targeted to each seller's own customers, but also may be setup with pricelists and pricing rules that apply to specific reseller-partners. Item prices and pricing rule setup data may be released and shared with reseller-partners. A security function may ensure that each enterprise may manage its own pricing data, but resellers may see and modify prices and pricing rules for products offered by their partners, if permitted to do so by the partner.

The CPQ system (and apparatus, and method) 1000 may enable a reseller or integrator to setup prices and pricing rules for their own customers. Resellers and integrators may setup prices and pricing rules for their own products, as well as for partners' products that they resell if authorized by the partner. The CPQ system (and apparatus, and method) 1000 may enable resellers to release product, product configuration, system configuration, and pricing data so it can be used by the reseller's affiliated users in creating sales quotations. The CPQ system (and apparatus, and method) 1000 may enable a sales quotation function that may allow the user to create a quote, identify the buyer, add one or more products to the quote, and/or launch the configurator for released configurable products and configurable systems, and/or display and tally product prices. The CPQ system (and apparatus, and method) 1000 may execute a product discovery function which may allow the integrator's own products, configurable systems, as well as products from multiple enterprises to be discovered and added to the quotation. The product discovery function may implement a security feature which may ensures that resellers may access released products and product data for which they are granted access by their partners. Enterprises may access products which they, themselves have defined and released in the system, but may not be able to access the products and product information set up by other enterprises unless they have specifically been granted access. The CPQ system (and apparatus, and method) 1000 may execute a product configuration function which may present options for a configurable product to the user so the user can define his or her desired configuration. The configuration function may enforce configuration rules that govern which options of the configurable product the user may select.

The CPQ system (and apparatus, and method) 1000 also may execute a systems configuration function which may present system-level options and may include configurable products. If configurable products are included in a system configuration, then one or more product configuration functions identified herein may execute for each configurable product.

The system CPQ system (and apparatus, and method) 1000 may execute a pricing function that may determine the price of each product for the customer who is the purchasing party on the quote. Note that these prices may be based on the prices that resellers and integrators offer to their own customers.

The CPQ system (and apparatus, and method) 1000 may be connected to a network (e.g. the “internet,” as illustrated in FIG. 6 to follow) so that it is accessible by users of a participating enterprise, regardless of location.

Implementation: CPQ Level 2.

As illustrated in FIG. 5, the CPQ system (and apparatus, and method) 1000 may be accessible by participating companies regardless of location (for example, over the “internet,” as illustrated in FIG. 6 to follow)

The CPQ system (and apparatus, and method) 1000 may include a data storage service (“database”) 340 that may include, as data elements, one or more of the lists defined herein to follow:

A non-limiting example list of companies authorized to use the system and participate in commercial processes with other companies also using the system:

Non-Limiting Example List of Companies:

Entity
Enterprise1
Enterprise2
Enterprise3

A non-limiting example list of users who are authorized to access the system, and the company with whom the user is affiliated.

Non-Limiting Example List of Users:

| Entity | User |
|---|---|
| Enterprise1 | User1-1 |
| Enterprise1 | User1-2 |
| Enterprise2 | User2-1 |
| Enterprise3 | User3-1 |

A non-limiting example list of pair-wise commercial relationships between companies, identifying the names of each company and the nature of the relationship. For non-limiting example, Enterprise 1—Sells wholesale goods to—Enterprise 2.

Non-Limiting Example List of Commercial Relationships:

| Entity | Commercial Relationship | Partner |
|---|---|---|
| Enterprise1 | Sells wholesale products to | Enterprise3 |
| Enterprise2 | Sells wholesale products to | Enterprise3 |

A non-limiting example list of products offered by each enterprise, as a list of enterprise-product associations.

Non-Limiting Example List of Enterprise Products

| Entity | Product |
|---|---|
| Enterprise1 | Product1-1 |
| Enterprise1 | Product1-2 |
| Enterprise2 | Product2-1 |
| Enterprise3 | System1 |

A non-limiting example list of access rights granted to partner-companies in a given company's trading network (“Reseller-Product Rights”). In some embodiments, this list of access rights could be an implied relationship. In some embodiments, the access rights may be explicitly stated.

Non-Limiting Example List of Product-Reseller Rights:

| Entity | Products Resold | Partner |
|---|---|---|
| Enterprise1 | Product1-1 | Enterprise3 |
| Enterprise2 | Product2-1 | Enterprise3 |

In some embodiments, access rights may be stated at the company-company level, implying rights to resell one or more products. For Non-limiting Example: Enterprise2 may be a reseller for Enterprise1 (implying one or more products of Enterprise1).

In some embodiments, reseller rights may be implied by other data, for non-limiting example because of the presence of a pricing list. For Non-limiting Example: Enterprise1 may create a pricing list called “Enterprise2 Reseller Pricelist.” The pricing list may include a product “Product1” at a price of $1.00.

In some embodiments, partners with whom configuration setup data has been shared may modify or extend the configuration models for products. This data may include configuration setup data that has been released and shared by a partner company. In the below non-limiting example, the product P1-1 (a car) is manufactured by Entity E1. The configurator set up data has been released by E1 as Version V1-1 and shared with Entity E3. E3 (a car dealer) has modified the configuration model for P1-1 by adding a Bicycle Rack option. The base version of the product model is also stored in the database as version V1, so that E1 may maintain it without overwriting E3's changes. In accessing this product model, only E3 would be able to access the Bicycle Rack option. In this embodiment, other resellers with whom E1 may have shared Product P1-1 may access the released version V1-1, but would not be able to access the Bicycle Rack option. In this embodiment, released configuration models may not be changed (only extended), so there is no need for Entity E3 to re-release the base Car model P1-1. However, there is a need for E3 to release the additions (the Bike Rack) in version V1-1-1.

### Non-Limiting Example List of Product Configuration Model Data

| | | | | Model | Model | Model | |
|---|---|---|---|---|---|---|---|
| | | | | Element | Element | Element | Extended |
| ID | Entity | Product | Version | Name | Type | Parent | Value |
| 1 | E1 | P1-1 | V1 | Car | Configurator | Null | |
| | | | | | Model | | |
| 2 | E1 | P1-1 | V1 | Trim | Option | 1 | |
| | | | | Level | Class | | |
| 3 | E1 | P1-1 | V1 | Base | Option | 2 | |
| 4 | E1 | P1-1 | V1 | Sport | Option | 2 | |
| 2 | E1 | P1-1 | V1 | Wheel | Option | 1 | |
| | | | | Options | Class | | |
| 3 | E1 | P1-1 | V1 | 17″ | Option | 2 | |
| | | | | Wheel | | | |
| 4 | E1 | P1-1 | V1 | 18″ | Option | 2 | |
| | | | | Wheel | | | |
| 5 | E1 | P1-1 | V1 | Wheel | Rule | 1 | Base |
| | | | | rules | | | trim |
| | | | | | | | level |
| | | | | | | | excludes |
| | | | | | | | 18″ |
| | | | | | | | wheel |
| 1 | E1 | P1-1 | V1-1 | Car | Configurator | Null | |
| | | | | | Model | | |
| 2 | E1 | P1-1 | V1-1 | Trim | Option | 1 | |
| | | | | Level | Class | | |
| 3 | E1 | P1-1 | V1-1 | Base | Option | 2 | |
| 4 | E1 | P1-1 | V1-1 | Sport | Option | 2 | |
| 2 | E1 | P1-1 | V1-1 | Wheel | Option | 1 | |
| | | | | Options | Class | | |
| 3 | E1 | P1-1 | V1-1 | 17″ | Option | 2 | |
| | | | | Wheel | | | |
| 4 | E1 | P1-1 | V1-1 | 18″ | Option | 2 | |
| | | | | Wheel | | | |
| 5 | E1 | P1-1 | V1-1 | Wheel | Rule | 1 | Base |
| | | | | rules | | | trim |
| | | | | | | | level |
| | | | | | | | excludes |
| | | | | | | | 18″ |
| | | | | | | | wheel |
| 6 | E3 | P1-1 | V1-1 | Bike | Option | 1 | |
| | | | | Rack | | | |
| 7 | E3 | P1-1 | V1-1-1 | Bike | Option | 1 | |
| | | | | Rack | | | |

Non-Limiting Example List of Reseller Data Access and Modification Rights:

| Entity | Partner | Authorization | Value |
|---|---|---|---|
| Enterprise1 | Enterprise3 | Modify list pricing | True |
| Enterprise1 | Enterprise3 | Include products in systems | True |
| Enterprise1 | Enterprise3 | Modify configuration models | False |
| | | excluding additions | |
| Enterprise1 | Enterprise3 | Make additions to configuration | True |
| | | models | |

A list of Product Prices, each of which may be designated for a particular Company. I.e. the same product could be sold from Enterprise1 to Enterprise3 at price X, and that same product could then be sold by Enterprise3 to Customer1 for price Y.

Non-Limiting Example List of Product Prices:

| Entity | | | |
|---|---|---|---|
| Enterprise1 | Product1-1 | Enterprise3 | $10,000.00 |
| Enterprise2 | Product2-1 | Enterprise3 | $15,000.00 |
| Enterprise3 | System1 | US Customers | $30,000 |

Some embodiments may include a set of data defining product configuration rules for each configurable product or system to be offered by a given company. Some embodiments may include shared configurable products as children.

In some embodiments, an administration component may allow an agent for a participating company to define product and/or configuration models and/or systems configuration models. Systems configuration rules may include but are not limited to references to released product configurations on offer by partners. According to some embodiments, if a Seller defines Product-Reseller Rights, making a given configurable product available to be resold by a given Reseller, then that product's released and shared configuration may be accessible in the Administration function for the Reseller. The administration component may identify presence and/or nature of relationships with other participating companies. The administration component assign rights for partner companies to resell one's (e.g., a user's) products, explicitly or implicitly as noted herein. The administration component may create product and/or systems prices for one's customers. The administration component may create reseller prices for one's reseller partners. The administration component may enable the release of product, configuration model, prices, and pricing rules for use in sales quotations by the Reseller's affiliated users.

Some embodiments may include a Sales Quotation component that may allow a User to perform one or more of the following actions: create a sales quotation, identify the customer (buyer), and/or specify commercial and/or pricing terms. Some embodiments may include a product search function that may enable released products and/or systems to be added to the quotation, while enforcing Reseller-Product Rights. In some embodiments, no agent of a company may see or otherwise interact with any product information in the database for which that user's company has not been granted the right to resell, implicitly or explicitly. In some embodiments, the configuration function may enforce configuration rules for configurable products and/or configurable systems.

Operation of the System and Component Behavior.

For non-limiting example, some embodiments may assume that data is populated in the Database for Companies called Enterprise1 and Enterprise2, with corresponding Users User1-1, User1-2, and User2-1. Some embodiments may also assume that product data is populated in the Database for Product1-1, Product1-2, and Product2-1. Some embodiments may also assume that Product Configuration rules are setup for Product1-2 and Product2-1.

According to some embodiments, for non-limiting example, new company Enterprise3 may wishes to use some embodiments to participate in commercial activity with Enterprise1 and Enterprise2. Enterprise3 may be an Integrator, selling Systems that include products manufactured by Enterprise1 and Enterprise 2. The following entries may be entered into the database, to set up Enterprise 3:
1. [System Administrator] Add Enterprise3 to the List of Companies.
2. [Enterprise3 Administrator] Add User3-1 to the List of Users.
3. [Enterprise1 Administrator] Add “Enterprise1—Sells Wholesale Products To—Enterprise3” to the List of Commercial Relationships.
4. [Enterprise2 Administrator] “Enterprise2—Sells Wholesales Products To—Enterprise3” to the List of Commercial Relationships.
5. [Enterprise1 Admin] Add “Enterprise1, Product1-1, Enterprise3” to the List of Product Reseller Rights, making product 1-1 available for resale to Enterprise3.
6. [Enterprise2 Admin], Add “Enterprise2, Product2-1, Enterprise3,” to the List of Product Reseller Rights, making product 2-1 available for resale to Enterprise3.
7. [Enterprise1 Admin] Release a version of product and configuration data for use by some users, including Enterprise3.
8. [Enterprise2 Admin] Release a version of product and configuration data for use by some users, including Enterprise3.
9. [Enterprise3 Admin] Add data representing the configuration for System1 to the list of Product Configuration Model Data.
10. [Enterprise1 Admin], Add the following data to the Product Price List: “Enterprise1, Product1-1, Enterprise3, $10,000”.
11. [Enterprise2 Admin], Add the following data to the Product Price List:
   “Enterprise2, Product2-1, Enterprise3, $15,000”.
   [Enterprise3 Admin], Add the following data to the Product Price List:
      “Enterprise3, Product1-1, US Customers, $13,500” and “Enterprise3, Product2-1, US Customers,” “$17,500,” which sets up Product1-1 and Product2-1 for sale to any Enterprise3 customer in the United States.
   [Enterprise3 Admin]: “Enterprise3, System1, US Customers, $30,000” which sets up System1 for sale to any customer in the United States.
12. [Enterprise3 Admin]: Release System1 for use in sales quotations.

As such, according to some embodiments, for non-limiting example, agents of Enterprise3 may now use some embodiments to prepare sales quotations for their customers. User3-1 may log into the CPQ system (and apparatus, and method) 1000. The CPQ system (and apparatus, and method) 1000 may process the login, look up User3-1, and may identify User3-1 as affiliated with Enterprise3. The Sales Quotation module may provide a mechanism for the user to add Products to the Quote. The mechanism may check the List of Product-Reseller Rights in the Database, in order to determine which Products agents of Enterprise3 are permitted to access. In this non-limiting example, according to some embodiments, System1 may be available since it was created by Enterprise3's Administrator and released for use. Some embodiments may run a check on the products included the CPQ system (and apparatus, and method) 1000 System, in order to ensure that child products of the CPQ system (and apparatus, and method) 1000 are permitted to be sold by Enterprise3. User3-1 may configure the System, which may include configuring the child products (Product1-1 and Product2-1). When configuration is complete, the Price for the configured System may be shown in the Quote.

Next, FIG. 6 illustrates a computer network (and system) or similar digital processing environment, according to some embodiments. Client computer(s)/devices 50 and server computer(s) 60 provide processing, storage, and input/output devices executing application programs and the like. The client computer(s)/devices 50 can also be linked through communications network 70 to other computing devices, including other client devices/processes 50 and server computer(s) 60. The communications network 70 can be part of a remote access network, a global network (e.g., the Internet), a worldwide collection of computers, local area or wide area networks, and gateways that currently use respective protocols (TCP/IP, Bluetooth®, etc.) to communicate with one another. Other electronic device/computer network architectures are suitable.

Client computers/devices 50 may be configured with a configuration module. Server computers 60 may be configured as the administration modules which communicate with client devices (i.e., configuration modules) 50 for providing access to product models. The server computers 60 may not be separate server computers but part of cloud network 70. In some embodiments, the server computer (e.g., administration module) may enable users to setup access rights of other users to received (or generated or accessed) product models that may be located on the client 50, server 60, or network 70 (e.g., global computer network). The client (configuration module) 50 may communicate information regarding product models back to and/or from the server (administration module) 60. In some embodiments, the client 50 may include client applications or components (e.g., configuration module) executing on the client 50 for generating or receiving (or accessing) product models shareable amongst users of the multiuser site, and the client 50 may communicate this information to the server (e.g., administration module) 60.

Each received (or generated or accessed) product model (stored on the client 50, server 60, and/or network 70) may relate to one or more respective manufacturable products and may include: product data of the manufacturable product, configuration rules, and/or prices for the manufacturable product. A user with access rights to the received (or generated or accessed) released product model may execute the received (or generated or accessed) product model (on the client 50, server 60, and/or network 70) to produce a certain price quote for a user-selected configuration of the corresponding manufacturable product or service.

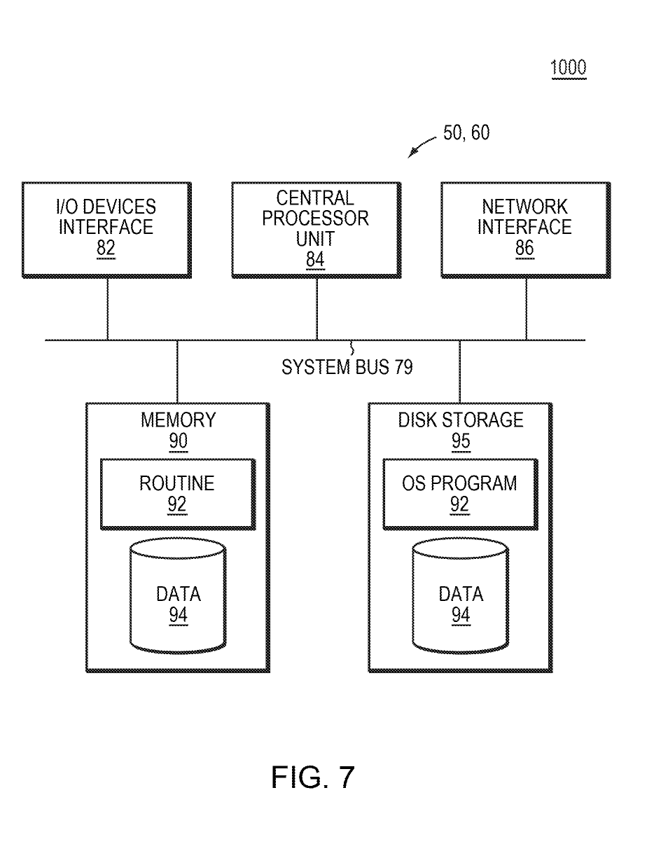

According to some embodiments, FIG. 7 is a diagram of an example internal structure of a computer (e.g., client processor/device 50 or server computers 60) in the computer system of FIG. 6. Each computer 50, 60 contains a system bus 79, where a bus is a set of hardware lines used for data transfer among the components of a computer or processing system. The system bus 79 is essentially a shared conduit that connects different elements of a computer system (e.g., processor, disk storage, memory, input/output ports, network ports, etc.) that enables the transfer of information between the elements. Attached to the system bus 79 is an I/O device interface 82 for connecting various input and output devices (e.g., keyboard, mouse, displays, printers, speakers, etc.) to the computer 50, 60. A network interface 86 allows the computer to connect to various other devices attached to a network (e.g., network 70 of FIG. 6). Memory 90 provides volatile storage for computer software instructions 92 and data 94 used to implement some embodiments (e.g., multiuser site, configuration module, and/or administration module engine elements described herein). Disk storage 95 provides non-volatile storage for computer software instructions 92 and data 94 used to implement an embodiment of the present disclosure. A central processor unit 84 is also attached to the system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Embodiments or aspects thereof may be implemented in the form of hardware (including but not limited to hardware circuitry), firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, hardware, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers including but not limited to both single-tenant and multi-tenant systems, and/or some combination thereof, and, thus, the data processors described herein are intended for purposes of illustration only and not as a limitation of the embodiments.

While this disclosure has been particularly shown and described with references to example embodiments thereof, it will be understood by those skilled in the art that various changes in form and details may be made therein without departing from the scope of the disclosure encompassed by the appended claims.

Some embodiments may provide one or more technical advantages that may transform the behavior and/or data, provide functional improvements, and/or solve a technical problem. As described herein, such a technical advantage may be applied to one or more partners including but not limited to resellers, integrators, and dealers.

As such, some embodiments may transform the behavior and/or data of received (or generated or accessed) product models by enabling user access rights to different received (or generated or accessed) product models of other users. Behavior and/or data of the received (or generated or accessed) product models may relate to one or more respective manufacturable products and may include product data of the one or more manufacturable products, configuration rules, and/or prices for the one or more manufacturable products.

Some embodiments may provide functional improvements to the quality of CPQ computer applications, CPQ systems, methods, or processes, product models associated with CPQ systems, methods or processes, and/or computer code by enabling the users to setup access rights of other users to the received (or generated or accessed) product models, such that different users have access rights to different received (or generated or accessed) product models of other users. As such, some embodiments may provide access to modify and/or execute product models (including but not limited to shared product models), thereby providing a substantial functional improvement.

Some embodiments solve a technical problem (thereby providing a technical effect) by providing a setup of access rights of other users to the received (or generated or accessed) product models, such that different users have access rights to different received (or generated or accessed) product models of other users.

In addition, some embodiments may provide one or more other technical advantages that may transform the behavior and/or data, provide functional improvements, and/or solve a technical problem. As such, some embodiments may provide several technical advantages, including but not limited to the following. It may be advantageous for an enterprise operating as a reseller to have access to its own CPQ system, with which it may offer products from any source partner (seller) for resale. Some embodiments may overcome the challenges of product configuration setup and maintenance, which may pose a practical obstacle to any company other than the product's manufacturer. As such, some embodiments may encourage a reseller to create its own product configurator for a partner's products. Some embodiments may deploy a Configuration-Price-Quote (CPQ) system that may allow configured product from partner manufacturers to be configured and quoted. Some embodiments may include a CPQ system that may be accessible to multiple enterprises, so that each enterprise may setup configuration rules for its own products. Some embodiments may include a CPQ system that may enable multiple enterprises to prepare quotations for their customers, while using product configurations setup by the partner companies.

Some embodiments may provide additional technical advantages, including but not limited to the following. In some embodiments, it may be valuable to an enterprise operating as a dealer or integrator to have access to its own CPQ system, with which it may offer configured systems that include configurable products from any source partner (seller) for resale. Some embodiments may overcome the challenges of product configuration setup and maintenance that may pose a practical obstacle to any company other than the product's manufacturer. As such, some embodiments may encourage an integrator to create its own product configurator for a partner's products. In some embodiments, an integrator may deploy a CPQ system that may include configured product from partner manufacturers. Some embodiments may be accessible to multiple enterprises, so that each enterprise may setup configuration rules for its own products, is novel. Some embodiments may include a CPQ system that may enable a reseller to modify or extend a partner manufacturer's shared configuration models. Some embodiments may include a CPQ system that may enable an integrator to define systems-level configurations, which may include configurable products from other enterprises. Some embodiments may include a CPQ system that may allow multiple enterprises to prepare quotations for their customers, while using product configurations setup by partner companies, is novel.

What is claimed is:

1. A computer apparatus, comprising:
at least one processor; and
memory with computer code instructions stored thereon, the memory operatively coupled to the at least one processor such that, when executed by the at least one processor, the computer code instructions cause the computer system to implement:
a multiuser site on a global computer network;
a configuration module communicatively coupled to the multiuser site for generating or receiving product models shareable amongst users of the multiuser site;
and an administration module enabling the users to setup access rights of other users to the product models, such that different users have access rights to different product models of other users;
wherein each product model relates to one or more respective manufacturable products and includes: product data of the manufacturable product, configuration rules, and prices for the manufacturable product,
wherein a user with access rights to the product model executes the product model to produce a certain price quote for a user-selected configuration of the corresponding manufacturable product or service.

2. The computer apparatus of claim 1, wherein the product model is a runtime product model.

3. The computer apparatus of claim 1, wherein the administration module further enables the users to setup the access rights of the other users, including users affiliated with business entities other than the user's own business entity, to released and shared product models and product model setup data, such that the different users have access rights to the different product models and set up data of other entities and authorizations to perform one or more operations upon the data to which the different users have access; and further comprising:
a set up module enabling users to define product, configuration, and pricing data, configured to control access to the product, configuration, and pricing data such that a user may access data to which the user is entitled and perform operations for which the user is authorized; and
a release module that creates a version of a set of the product, configuration, and price data for sharing with the other users, configured to controls access to the product, configuration, and price data such that a user may further access data to which the user is entitled and further perform operations for which the user is authorized;
wherein a user may access, create, update, and otherwise manage the product, configuration, and pricing data for the entity with which the user is affiliated;
wherein a user may assign access rights to the data of the user's own affiliated entity, and authorize specific operations upon the affiliated data; and
wherein a user may release a version of the product, configuration, and pricing data to be used by one or more entitled users to prepare one or more sales quotations for configured products.

4. The computer apparatus of claim 1, where the user with access rights to the product model further executes the product model to access multiple configurations of the corresponding manufacturable product or service.

5. The computer apparatus of claim 1, wherein the user with access rights includes at least one of: a manufacturer user and a partner user.

6. The computer apparatus of claim 5, wherein the partner user is at least one of: a reseller, an integrator, and a dealer.

7. The computer apparatus of claim 5, wherein the manufacturer user accesses the administration module to indicate, with respect to the other users, access to the product models.

8. The computer apparatus of claim 5, wherein the administration module enables the user with access rights to modify the shared product models.

9. The computer apparatus of claim 8, wherein the administration module further enables the user with access rights to enhance or extend the product models shared with the user or to incorporate the shared product models into other configuration models of the user.

10. A method of providing price quoting for a multiuser site on a global network, the method comprising:
generating or receiving, by a processor, product models for a multiuser site, the product models being shareable amongst users of the multiuser site; and
enabling the users to setup access rights of other users to the product models, such that different users have access rights to different product models of other users;
wherein each product model relates to one or more respective manufacturable products and includes: product data of the manufacturable product, configuration rules, and prices for the manufacturable product,
wherein a user with access rights to the product model executes the product model to produce a certain price quote for a user-selected configuration of the corresponding manufacturable product or service.

11. The method of claim 10, where the user with access rights to the product model further executes the product model to access multiple configurations of the corresponding manufacturable product or service.

12. The method of claim 10, wherein the user with access rights includes at least one of: a manufacturer user and a partner user.

13. The method of claim 12, wherein the partner user is at least one of: a reseller, an integrator, and a dealer.

14. The method of claim 12, wherein the manufacturer user accesses the administration module to indicate, with respect to the other users, access to the product models.

15. The method of claim 12, further comprising enabling the user with access rights to modify the shared product models.

16. The method of claim 15, further comprising further enabling the user with access rights to enhance or extend the product models shared with the user or to incorporate the shared product models into other configuration models of the user.

17. A non-transitory computer readable medium having stored thereon a sequence of instructions which, when loaded and executed by a processor coupled to an apparatus, causes the apparatus to:
generate, by a processor, product models for a multiuser site, the product models being shareable amongst users of the multiuser site; and
enable the users to setup access rights of other users to the product models, such that different users have access rights to different product models of other users;
wherein each product model relates to one or more respective manufacturable products and includes: product data of the manufacturable product, configuration rules, and prices for the manufacturable product,
wherein a user with access rights to the product model executes the product model to produce a certain price quote for a user-selected configuration of the corresponding manufacturable product or service.

18. The non-transitory computer readable medium of claim 17, wherein the user with access rights includes at least one of: a manufacturer user and a partner user.

19. The non-transitory computer readable medium of claim 18, wherein the partner user is at least one of: a reseller, an integrator, and a dealer.

20. The non-transitory computer readable medium of claim 18, wherein the manufacturer user accesses the administration module to indicate, with respect to the other users, access to the product models.

21. The non-transitory computer readable medium of claim 18, wherein the apparatus enables the user with access rights to modify the shared product models.

22. The non-transitory computer readable medium of claim 21, wherein the apparatus further enables the user with access rights to enhance or extend the product models shared with the user or to incorporate the product models into other configuration models of the user.
